(19) United States
(12) Patent Application Publication
(10) Pub. No.: US 2026/0060898 A1
(43) Pub. Date: Mar. 5, 2026

(54) MEDICINE DISPENSER, MEDICINE DISPENSING SYSTEM COMPRISING THE MEDICINE DISPENSER

(71) Applicant: Jay Won KIM, Seoul (KR)

(72) Inventor: Jay Won KIM, Seoul (KR)

(21) Appl. No.: 18/816,712

(22) Filed: Aug. 27, 2024

(51) Int. Cl. A61J 7/04; G06K 7/10; G06K 19/07

(52) U.S. Cl. CPC A61J 7/0427; G06K 7/10297; G06K 19/0723

(57) ABSTRACT

A medicine dispenser includes: a main body forming the overall appearance of the medicine dispenser, a first main door and a second main door arranged at the rear of the main body and openable, a main chamber defined by the main body, the first main door, and the second main door, a touchscreen device arranged at the front of the main body to provide medicine dispensing information and manage a medicine dispensing mechanism, a grid chamber mounted in the main chamber and into which at least one cartridge containing a medicine is inserted, and at least one cartridge containing a medicine and including an NFC/RFID chip storing information about the medicine, wherein the grid chamber includes a plurality of slots into which the cartridge is inserted, and the slots include an NFC/RFID reader for reading the NFC/RFID chip included in the cartridge.

### BACKGROUND OF THE INVENTION

### Field of the Invention

The present invention relates to a medication dispenser, and a medication dispensing system comprising the medication dispenser.

### Background of the Related Art

In modern society, with the growing interest in health, many consumers try to take nutritional supplements, but not only do they not understand the correct way to take them, they often forget to take them due to their busy lives.

Especially for patients taking prescription medications, it is important to take prescription medications according to the correct dosage instructions, as overdosing and under dosing can have serious side effects. In addition, it is difficult for a physician or healthcare professional to verify that a patient has taken the prescribed medication correctly, and therefore it is difficult to ensure that the prescribed medication is appropriate for the patient.

Therefore, there is a need for a system that can monitor in real-time whether patients are taking their prescribed medication as prescribed, while also preventing overuse.

### SUMMARY OF THE INVENTION

Accordingly, the present invention has been made in view of the above-mentioned problems occurring in the prior art, and it is an object of the present invention to provide a medication dispenser, and a medication dispensing system comprising the medication dispense, which can monitor in real time whether a patient is taking a prescribed medication according to a prescribed dosage method, while preventing over-medication.

The technical problems of the present invention are not limited to the technical problems mentioned above, and unmentioned other technical problems will be clearly understood by those skilled in the art from the following description.

To accomplish the above object, according to an aspect of the present invention, there is provided a medicine dispenser comprising: a main body forming the overall appearance of the medicine dispenser, a first main door and a second main door arranged at the rear of the main body and openable, a main chamber defined by the main body, the first main door, and the second main door, a touchscreen device arranged at the front of the main body to provide medicine dispensing information and manage a medicine dispensing mechanism, a grid chamber mounted in the main chamber and into which at least one cartridge containing a medicine is inserted, and at least one cartridge containing a medicine and including an NFC/RFID chip storing information about the medicine, wherein the grid chamber includes a plurality of slots into which the cartridge is inserted, and the slots include an NFC/RFID reader for reading the NFC/RFID chip included in the cartridge, and wherein the touchscreen device dispenses the medicine based on the information about the medicine read through the NFC/RFID reader, wherein the information about the medicine includes at least one of the type of the medicine, information about the designated medicine user, information about the prescribing doctor, and a method of administration.

According to the medication dispenser, and the medication dispensing system comprising the medication dispense according to the embodiments

The touchscreen device may include a processor and a memory that execute an application for managing the medicine dispensing mechanism, and the touchscreen device provides a notification regarding the taking of the medicine to a user terminal of a medicine user according to preset conditions.

The touchscreen device may transmit a notification to the user terminal of the doctor who prescribed the medicine to the medicine user, informing the user of the fact if the medicine user has not received the medicine for a preset period of time.

The medicine dispenser may dispense medicines to a plurality of medicine users, and the touchscreen device may dispense medicines to the plurality of medicine users based on information read from an NFC/RFID chip contained in each of the plurality of cartridges.

The medicine dispenser further comprising: a medicine dispensing port disposed at the front lower portion of the main body and including a plastic hood, a cup disposed inside the medicine dispensing port and containing medicines dispensed from the at least one cartridge, a side compartment disposed on one side of the medicine dispensing port and capable of connecting with the medicine dispensing port by the control of the touchscreen device, a moving mechanism for moving the cup from the medicine dispensing port to the side compartment, and wherein the side compartment may include a window that can be opened to connect with the outside.

The touchscreen device may control whether the first main door and the second main door are opened or closed and whether the window of the side compartment is opened or closed based on the authentication of an authorized user.

The grid chamber may further include a plurality of infrared sensors arranged at the front end of each of the plurality of slots to count the number of medicines dispensed from the plurality of slots.

The grid chamber may further include: a plurality of buttons arranged corresponding to each of the plurality of slots and for separating the cartridge from the plurality of slots, and a plurality of LEDs arranged corresponding to each of the plurality of slots and for indicating whether a cartridge is placed in the slot and whether all of the medicine contained in the cartridge has been dispensed.

The cartridge may include: a body having a shape corresponding to the slot and forming the outer shape of the cartridge, the NFC/RFID chip arranged on one side of the body, flaps arranged on the front end of the body and openable by controlling an electrical signal, connectors for receiving electrical energy from the touchscreen device, a volume control member and a volume control panel arranged in the internal space of the body for controlling the volume of a medicine storage space containing a medicine in the thickness direction of the cartridge, and a conveyor belt and a driving motor for controlling the volume of the medicine storage space in the horizontal direction of the cartridge.

The above volume control member may include a plurality of gears and a shaft mechanism arranged corresponding to the gears, and the volume control panel is arranged to divide the internal space of the body into upper and lower spaces in the thickness direction, and the volume control member pressurizes the volume control panel to control the volume of the medicine storage space.

The conveyor belt may include a main belt and a notch arranged at one end of the main belt, and the driving motor engages with the conveyor belt to move the conveyor belt in the horizontal direction, and the medicine contained in the cartridge is pushed in the direction of the flaps by the notch.

According to one aspect of the invention, there is provided a medicine dispensing system comprising: the medicine dispenser according to the above medicine dispenser, a user terminal possessed by a medicine user using the medicine dispenser and a doctor who prescribed the medicine to the medicine user, and a service platform that provides a medicine dispensing-related service to the medicine user in conjunction with the medicine dispenser, wherein the service platform comprises: an interface module that provides an application program to the medicine dispenser and the user terminal and performs data communication, a monitoring module that monitors the operation and status of the medicine dispenser, a scheduling module that schedules a medicine dispensing method of the medicine dispenser based on a prescription prescribed by the doctor.

The interface module may provide suitable data and user interface as visual screens for each of the user terminal of the medicine user and the user terminal of the doctor.

When the medicine dispenser dispenses medicines to a plurality of medicine users, the monitoring module may generate monitoring data for each of the plurality of medicine users and provides a notification.

The service platform may further include: a user management module storing information about each of a plurality of medicine users, and a medicine management module storing information about a plurality of medicines, wherein the scheduling module schedules a medicine dispensing method of a medicine dispenser based on the prescription, information about the medicine user, and information about the medicine, wherein the information about the medicine user includes personal information about the medicine user, a list of prescribed medicines, and information about a medicine dispenser being used by the medicine user, and wherein the information about the medicine includes an appropriate dosage, a dosing cycle, and an interaction with another medicine for each of the plurality of medicines.

### BRIEF DESCRIPTION OF THE DRAWINGS

The above and other aspects and features of the present disclosure will become more apparent by describing in detail embodiments thereof with reference to the attached drawings, in which:

FIG. 1 is a schematic drawing of a medicine dispensing system according to one embodiment of the present invention.

FIG. 2 is a block diagram schematically showing the configuration of a service platform according to one embodiment of the present invention.

FIG. 3 is a perspective view of a medicine dispenser according to one embodiment of the present invention.

FIG. 4 is a front view of a medicine dispenser according to one embodiment of the present invention.

FIG. 5 is a plan view of a medicine dispenser according to one embodiment of the present invention.

FIG. 6 is a perspective view of a grid chamber according to one embodiment of the present invention.

FIG. 7 is a front view of a grid chamber according to one embodiment of the present invention.

FIG. 8 is a plan view of a grid chamber according to one embodiment of the present invention.

FIG. 9 is a plan perspective view of a medicine dispenser containing a grid chamber according to one embodiment of the present invention.

FIG. 10 is a perspective view of a cartridge according to one embodiment of the present invention.

FIGS. 11 and 12 are side perspective views of a cartridge according to one embodiment of the present invention.

### DETAILED DESCRIPTION OF THE PREFERRED EMBODIMENT

Hereinafter, preferred embodiments of the present invention will be described in detail with reference to the accompanying drawings in order to clarify the technical spirit of the present invention. In describing the present invention, when it is determined that detailed description of a related well-known function or component may unnecessarily obscure the gist of the present invention, the detailed description will be omitted. Components having substantially the same functional configuration in the drawings are given the same reference numerals and reference symbols as much as possible even though they are shown in different drawings. For convenience of explanation, the device and the method will be described together if necessary.

Although first, second, and the like are used to describe various components, it is apparent that these components are not limited by these terms. These terms are used only to distinguish one component from another. Accordingly, it goes without saying that a first component mentioned below may be a second component within the spirit of the present invention.

As used herein, the singular forms “a”, “an” and “the” are intended to include the plural forms as well, unless the context clearly indicates otherwise.

Hereinafter, the term “unit” is defined herein as having its broadest definition to ordinary skill in the art to refer to software including instructions executable in a non-transitory computer-readable medium that would perform the associated function when executed, a circuit or a processor designed to perform the associated function, hardware designed to perform the associated function, or a combination of them.

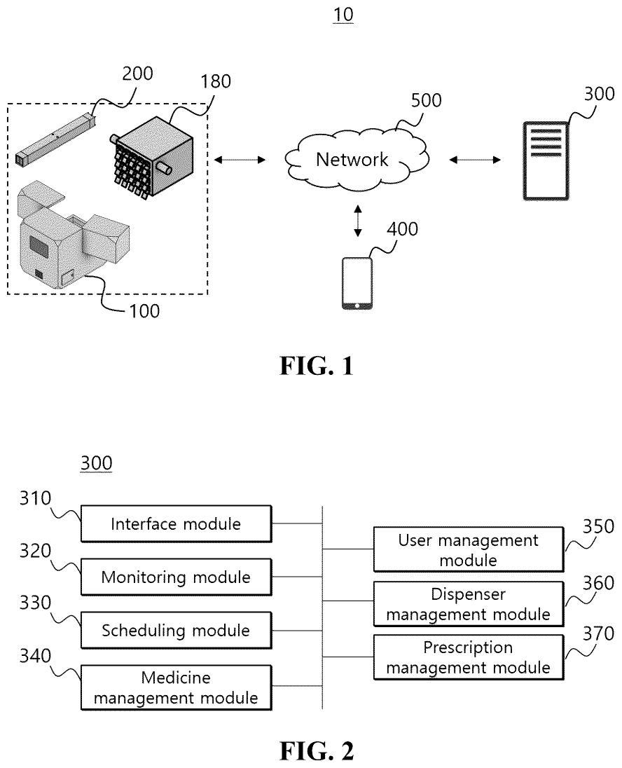

FIG. 1 is a schematic drawing of a medicine dispensing system according to one embodiment of the present invention.

Referring to FIG. 1, a medicine dispensing system (10) according to one embodiment may include a medicine dispenser (100) including a grid chamber (180), at least one cartridge (200) insertable into the grid chamber (180), a service platform (300), at least one user terminal (400), and a network (500).

The medicine dispensing system (10) can provide medicine dispensing and monitoring services to users by connecting a medicine dispenser (100), a service platform (300), and at least one user terminal (400) through a network (500).

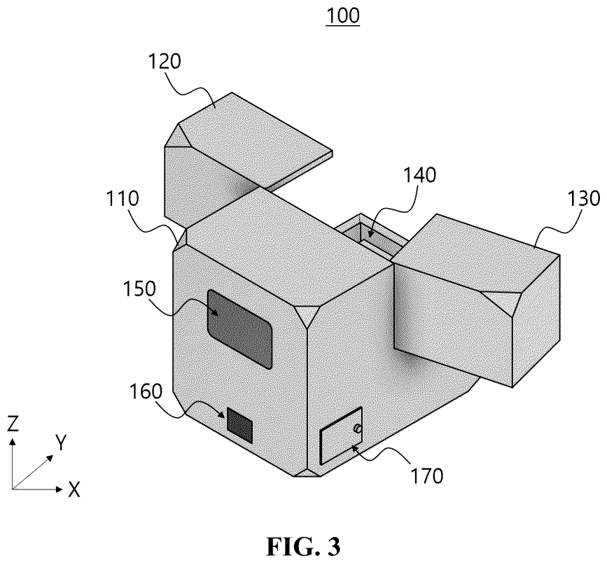

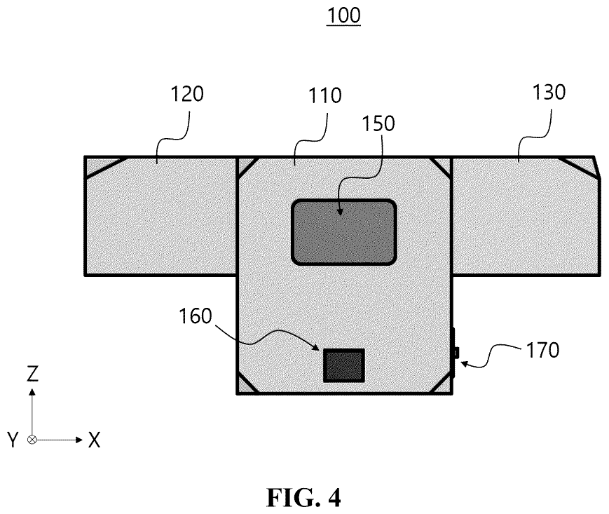

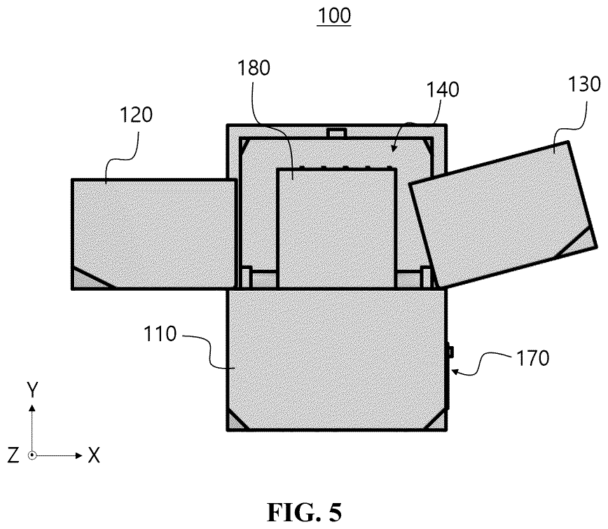

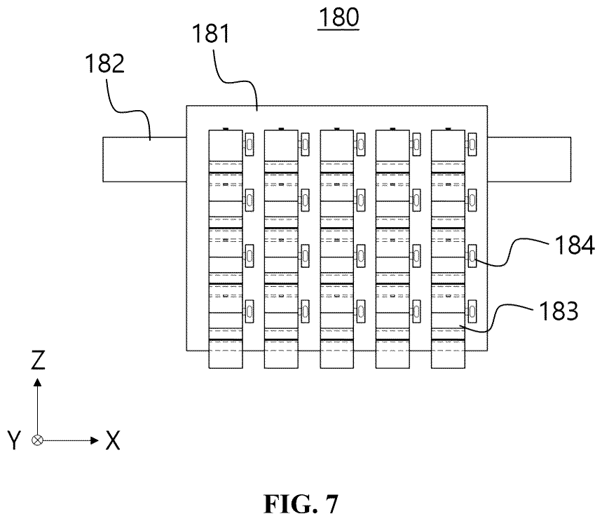

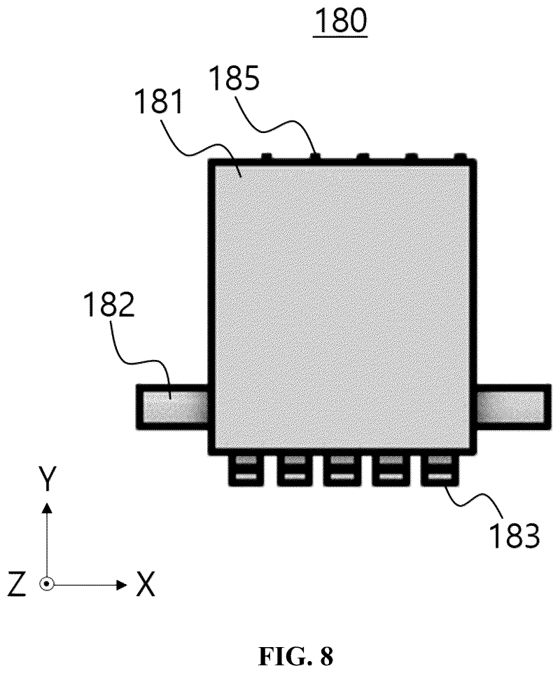

The medicine dispenser (100) can dispense at least one medicine to a user according to preset conditions. The medicine dispenser (100) can include an independent computing system. The medicine dispenser (100) includes a computing system including a processor, a memory, an input/output interface, etc., and can perform data communication with the service platform (300) and the user terminal (400) through a network (500). In addition, the medicine dispenser (100) can drive an application program and/or an application provided by the service platform (300) or drive an application built into itself. A detailed description of the medicine dispenser (100) will be described later with reference to FIGS. 3 to 9.

The service platform (300) can be connected with the medicine dispenser (100) to provide a medicine distribution-related service to a user using a user terminal (400). The service platform (300) can provide an application that can be installed and operated on the user terminal (200) and provide a medicine distribution-related service through the application.

For example, the service platform (300) can make an appointment for a doctor (or a medicine specialist) to provide medical-related services through the application, and check the reservation details and information about the patient's condition for each patient. The service platform (300) provides a single management page for each patient through the application, and the single management page can include, but is not limited to, information about the patient's information, whether the patient is taking medication, the patient's past medical records and prescriptions, notes about the patient, etc.

The service platform (300) can provide a user taking medication (i.e., a patient) with a list of doctors, a list of prescribed medications, a scheduled treatment schedule, and a report on how well the patient is taking the medication through the application. In some embodiments, the patient can also make an appointment with the doctor through the application provided by the service platform (300).

In addition, the service platform (300) also provides the patient with specific information about the prescription, such as the therapeutic purpose and potential side effects of each medicine, and the patient can also record additional information about his/her health, such as blood sugar levels, average heart rate, and average blood pressure, in the application provided by the service platform (300) through the user terminal (400). The application provided to the user terminal (400) used by the patient by the service platform (300) may be embedded in the medicine dispenser (100) carried by the patient or may be linked with the application provided.

A detailed description of the service platform (300) will be described later with reference to FIG. 2.

The user terminal (400) is a smart device carried by the user, and for example, the user terminal (400) may include a mobile phone, a smart phone, a smart pad, a notebook computer, a digital broadcasting terminal, a PDA (Personal Digital Assistants), a PMP (Portable Multimedia Player), a navigation, a tablet PC, and various wearable devices such as a smart watch and a smart band. The user terminal (400) may install and run an application program and/or an application provided by the service platform (300).

The user terminal (400) may exchange data with the service platform (300) and the medicine dispenser (100) through a network (500). The user using the user terminal (400) may include, but is not limited to, a patient (or, a medicine user) taking a medicine through the medicine dispenser (100) and a doctor (or, a medicine expert) prescribing the medicine to the patient.

The network (500) is a communication network in which a medicine dispenser (100), a service platform (300), and a user terminal (400) communicate with each other, and can be configured regardless of the communication mode. For example, it can be configured as various communication networks such as a Personal Area Network (PAN), a Local Area Network (LAN), a Metropolitan Area Network (MAN), and a Wide Area Network (WAN), but is not limited thereto.

FIG. 2 is a block diagram schematically showing the configuration of a service platform according to one embodiment of the present invention.

Referring to FIG. 2, a service platform (300) according to one embodiment of the present invention may include an interface module (310), a monitoring module (320), a scheduling module (330), a medicine management module (340), a user management module (350), a dispenser management module (360), and a prescription management module (370)

The interface module (310) may perform a function of controlling the overall operation of each component constituting the system (100). For example, the interface module (310) may perform a role of data communication, linkage, and interlocking between each component. The interface module (310) may provide an application program and/or an application to the user terminal (400) and perform data communication with the medicine dispenser (100) and the user terminal (400). In some embodiments, the interface module (310) may also provide an application to the medicine dispenser (100).

The interface module (310) can provide suitable data and user interface as a visual screen for each of the user terminal (400) of the medicine user and the user terminal (400) of the doctor.

The monitoring module (320) can monitor the operation and status of the medicine dispenser (100). For example, the monitoring module (320) can be linked with the medicine dispenser (100) in real time to monitor the status of the medicine dispenser (100). As a specific example, the monitoring module (320) can monitor whether the medicine dispenser (100) dispenses the medicine according to preset conditions, whether the dispensed medicine is received by the user, the status of the grid chamber (180), and information about at least one cartridge (200) mounted in the grid chamber (180) (for example, the type of medicine included in the cartridge (200), the weight of one medicine, the amount, the duration of administration, etc.). The monitoring module (320) can generate monitoring data on the operation and status of the medicine dispenser (100) and provide it to the user terminal (400).

The monitoring module (320) can provide a notification to the user terminal (400) according to the status of the medicine dispenser (100). For example, if the medicine dispenser (100) dispenses a medicine according to a preset condition, but the medicine user does not receive the dispensed medicine within a certain period of time, the monitoring module (320) can provide a notification to the user terminal (400) of the medicine user to receive the dispensed medicine. In this case, the monitoring module (320) can also provide a notification to the user terminal (400) of the doctor who prescribed the dispensed medicine.

As an additional example, if the medicine dispensed by the medicine dispenser (100) is not received by the medicine user within a certain period of time and is thus discarded or stored, the monitoring module (320) can provide a notification to the user terminal (400) of the medicine user and/or the doctor, informing of the fact.

In some embodiments, when the medicine dispenser (100) dispenses medicines to multiple medicine users, the monitoring module (320) may generate monitoring data for each of the multiple medicine users and provide a notification.

The scheduling module (330) can schedule the medicine dispensing method of the medicine dispenser (100) based on information about the medication prescribed by a doctor or entered by a medicine expert. For example, the scheduling module (330) can schedule the medicine dispensing method (i.e., the type of the medication and the dispensing cycle) of the medicine dispenser (100) based on information about the medicine user and information about the medication stored in the medication management module (340).

Here, the information about the medicine user includes personal information (gender, age, underlying disease, biometric information, prescription information, etc.) of the medicine user stored in the user management module (350) and the prescription management module (370), and the information about the medication can include, but is not limited to, the appropriate dosage of the medication, the dosage cycle, and the relationship with other medications (whether they can be taken together, etc.).

The scheduling module (330) may schedule the medicine dispensing method of the medicine dispenser (100) on its own based on the medicine information prescribed by the doctor, but is not limited thereto, and may also schedule the medicine dispensing method of the medicine dispenser (100) based on scheduling data entered by a doctor with the authority to modify.

In some embodiments, the scheduling module (330) may reschedule the preset medicine dispensing method of the medicine dispenser (100) based on the monitoring data generated by the monitoring module (320). For example, if a medicine is dispensed by the medicine dispenser (100) but the medicine user does not receive the dispensed medicine, the scheduling module may schedule a medicine dispensing method suitable for the medicine user by reflecting the fact.

The scheduling module (330) can generate medicine dispensing scheduling data by scheduling a medicine dispensing method for a specific medicine dispenser (100) and user, and provide the generated data to the medicine dispenser (100) through the dispenser management module (360).

The medicine management module (340) can store information about multiple medicines. For example, the medicine management module (340) can include the appropriate dosage, dosing cycle, and interaction with other medicines for each of the multiple medicines. The medicine management module (340) can receive information about multiple medicines from the doctor's user terminal (400) and store and manage the information, but is not limited thereto. The medicine management module (340) can also collect and update information about multiple medicines from an external database or big data system.

The user management module (350) can store information about each of multiple users. For example, the user management module (350) can store and manage various information, such as information about a medicine user, such as personal information of the medicine user, a list of prescribed medicines, information about the user terminal (400) and medicine dispenser (100) possessed by the medicine user, a treating doctor, a list of prescribed medicines, a scheduled treatment schedule, a report on medicine use, etc.

Also, the user management module (350) can store and manage information, such as a list of patients treated by a doctor (or a medicine specialist), prescription history for each patient, a treatment schedule, information about a medicine dispenser (100) corresponding to a patient under management, and information about a user terminal (400) used by a doctor.

The dispenser management module (360) can store and manage information about the medicine dispenser (100). For example, when the service platform (300) manages multiple medicine dispensers (100), the dispenser management module (360) can store and manage information about the medicine dispenser (100) for each of the multiple medicine dispensers (100).

For example, the information about the medicine dispenser (100) can include information about at least one medicine user using the corresponding medicine dispenser (100), information about the medicine included in the medicine dispenser (100), information about the authority to insert or remove a cartridge containing the medicine from the medicine dispenser (100), etc.

The dispenser management module (360) can be linked with the interface module (310) to generate and/or update information about the medicine dispenser (100). For example, the user terminal (400) can register the medicine dispenser (100) for its own use (if the user is a patient) or for providing it to a patient (if the user is a doctor) through the application program and/or application provided by the interface module (310), and in this case, the dispenser management module (360) can generate or update information about the corresponding medicine dispenser (100).

The dispenser management module (360) can be linked to the medicine dispenser (100) through a network (500) to generate and/or update medicine information included in the medicine dispenser (100). As a specific example, as described below, the cartridge (200) inserted into the medicine dispenser (100) can include an RFID or NFC chip that stores medicine information included in the cartridge (200). In this case, the medicine dispenser (100) recognizes the RFID or NFC chip embedded in the cartridge (200) to read the medicine information, and the dispenser management module (360) can generate or update the medicine information included in the medicine dispenser (100).

In addition, the dispenser management module (360) can provide or update medicine distribution scheduling data generated by the scheduling module (330) to the corresponding medicine dispenser (100).

In some embodiments, when the service platform (300) provides an application and/or application to the medicine dispenser (100), the dispenser management module (360) can manage the application and/or application information distributed to the medicine dispenser (100) and provide an update function.

The prescription management module (370) can be linked with an external system (e.g., an electronic medical record system (EMR) of a hospital) to collect and manage medical records such as treatment records and prescription history for each of multiple users. The prescription management module (370) can encrypt and store and manage medical records according to its own encryption standard for personal information protection, and as a specific example, it can encrypt and store medical records using a block-chain system.

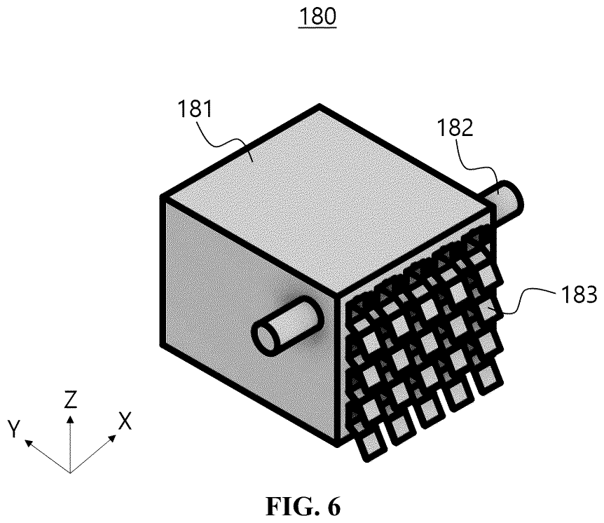

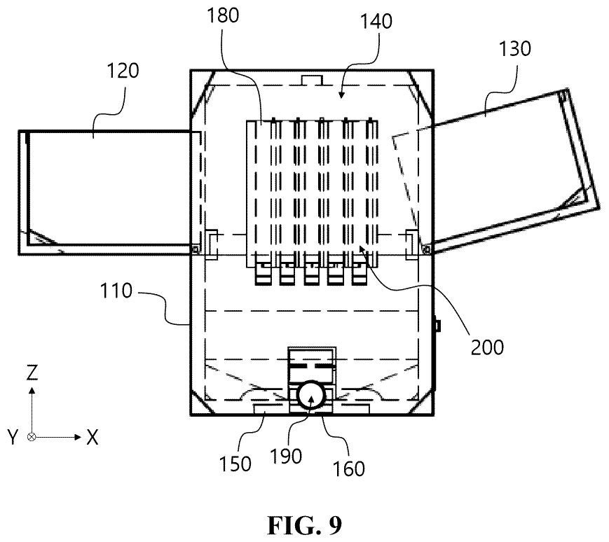

FIGS. 3 to 5 are a perspective view, a front view, and a plan view of a medicine dispenser according to one embodiment of the present invention, and FIGS. 6 to 8 are a perspective view, a front view, and a plan view of a grid chamber according to one embodiment of the present invention. FIG. 9 is a plan perspective view of a medicine dispenser containing a grid chamber according to one embodiment of the present invention.

In the drawings attached to this specification, the first direction (x-axis direction) may be a direction parallel to one side of the medicine dispenser (100) when viewed in a plan view, for example, a horizontal direction of the medicine dispenser (100). The second direction (Y-axis direction) may be a direction parallel to the other side that contacts one side of the medicine dispenser (100) when viewed in a plan view, and may be a vertical direction (or rear direction) of the medicine dispenser (100). The third direction (Z-axis direction) may be a thickness direction (or upper direction) of the medicine dispenser (100).

Referring to FIGS. 3 to 9, a medicine dispenser (100) according to one embodiment may include a main body (110), a first main door (120), a second main door (130), a main chamber (140), a touch screen device (150), a medicine dispensing port (160) including a plastic hood, a side compartment (170), a grid chamber (180), and a cup (190).

The main body (110) can form the overall outer shape of the medicine dispenser (100). According to one embodiment of the present invention, as shown in FIGS. 3 to 5, the main body (110) can have a hexahedral shape with an empty interior together with two main doors (120, 130) to be described later, but is not limited thereto. In other embodiments, the main body (110) can have various shapes, such as a polyhedral shape or a cylindrical shape having three or more faces.

Two main doors (120, 130) may be arranged at the rear of the main body (110). The first main door (120) and the second main door (130) may include an openable and closable mechanism. For example, a locking mechanism (not shown) may be arranged between the main body (110) and the two main doors (120, 130), so that locking or unlocking between the main body (100) and the two main doors (120, 130) may be implemented. In addition, the dispenser device (100) may detect whether the two main doors (120, 130) are opened or closed through the locking mechanism, but is not limited thereto, and the dispenser device (100) may further include a separate sensor for checking whether the two main doors (120, 130) are opened or closed.

The first main door (120) and the second main door (130) can be operated to open or close under the authentication of an authorized user by linking with an application built into the dispenser device (100). As a specific example, the authorized user can control the opening and closing of the first main door (120) and the second main door (130) by tagging an NFC/RFID device containing an authentication key to the medicine dispenser (100), but is not limited thereto.

The main chamber (140) may be a space defined by the main body (110) and two main doors (120, 130). The main chamber (140) may have various shapes depending on the shapes of the main body (110) and two main doors (120, 130). In the present embodiment, the main chamber (140) may be a hexahedral space. The main chamber (140) is a space in which the grid chamber (180) is arranged.

The touchscreen device (150) is a user interface device capable of input by touch and output by display, and can be placed on the front of the main body (110). The touchscreen device (150) can provide various information about the medication that the patient should take. For example, the touchscreen device (150) can provide various information about the patient's medication, such as how to take the medication, medications that should not be taken together, and the composition of the medication. In addition, the patient taking the medication and/or the doctor can set a schedule for dispensing the medication through the touchscreen device (150).

When multiple medicine users are dispensed medicines from a single medicine dispenser (100), the touchscreen device (150) can provide information about the medicines to each of the multiple medicine users. In this case, the touchscreen device (150) can provide information to indicate to which of the multiple medicine users the medicine is dispensed when the medicine dispenser (100) dispenses the medicine.

The touchscreen device (150) can be implemented as a standalone computing system including a processor and memory. The touchscreen device (150) can communicate data with the service platform (300) via a network (500). The touchscreen device (150) can drive an application program and/or application provided by the service platform (300) or pre-installed. The touchscreen device (150) can provide various information about the medicine described above based on data received from the service platform (300).

The application and/or applications embedded in the touchscreen device (150) can control the medicine dispensing mechanism. For example, as described below, based on information read from the NFC/RFID chip (220) of each of the plurality of cartridges (200) inserted into the medicine dispenser (100), the slot (183) in which the medicine is located and to whom the specific medicine should be administered are automatically detected, and the medicine user using the dispenser (100) can conveniently insert the provided cartridge into the desired location in the grid chamber (180).

The application and/or applications embedded in the touchscreen device (150) use an online clock to send an alarm to the patient to take the medication via the touchscreen device (150) of the dispenser (100) and the user terminal (400). When the patient decides to take the medication, the application and/or applications read the prescription, power up the cartridge (200) containing the listed medication, dispense the medication, and when the correct dosage is dispensed, power down the cartridge (200).

In addition, the touchscreen device (150) can control each component of the medicine dispenser (100). For example, the touchscreen device (150) can control and detect the operations of each component of the medicine dispenser (100), such as opening and closing operations of the two main doors (120, 130), dispensing of medicines by the grid chamber (180), checking whether the user has received the dispensed medicines, detecting whether the detachable cup (190) described below has been separated and returned, and moving the cup (190) to the side compartment (170).

In some embodiments, the touchscreen device (150) may include a biometric sensor. When controlling the operation of the medicine dispenser (100), the touchscreen device (150) may set authentication of the user via the biometric sensor as a condition when user authorization (e.g., authentication for receiving dispensed medicines, authentication for opening and closing the main door (120, 130), etc.) is required.

The touchscreen device (150) may provide a user interface for the medicine user to input that the medicine is to be taken before and/or after the medicine dispenser (100) dispenses the medicine. In some embodiments, if the medicine user does not provide input regarding medicine dispensing via the touchscreen device (150), the touchscreen device (150) may control the medicine dispenser (100) not to dispense the medicine. Additionally, in this case, the touchscreen device (150) may transmit a reminder to the user terminal (400) of the medicine user and/or the physician that the medicine user should take the medicine.

In another embodiment, when the touchscreen device (150) requests the medicine user to confirm receipt of the medicine after the medicine is dispensed by the medicine dispenser (100), the touchscreen device (150) may open the medicine dispensing port (160) only when input from the medicine user is made.

Furthermore, the touchscreen device (150) can detect whether the cup (190) has been removed or returned from the medicine dispensing port (160) through an object detection sensor (e.g., a camera sensor, etc.) placed at the medicine dispensing port (160), as described below. If the cup (190) has not been returned within a preset period after being removed from the medicine dispensing port (160), the touchscreen device (150) can display a notification to receive the cup (190) containing the dispensed medicine, and transmit the notification to the user terminal (400) of the medicine user and/or the doctor.

Additionally, if the medicine is dispensed into the cup (190) but not removed within a preset period of time, the touchscreen device (150) may transmit a notification to the user terminal (400) of the medicine user and/or the doctor, and move the cup (190) from the medicine dispensing port (160) to the side compartment (170).

The medicine discharge port (160) may be arranged at the lower portion of the front of the main body (110). The medicine discharge port (160) may include a transparent hood that can be opened and closed under the control of the touchscreen device (150). The medicine discharge port (160) may include a space for arranging a detachable cup (190) therein. The medicine discharge port (160) may dispense medicines from a plurality of cartridges (200) arranged in the grid chamber (180) through a separate medicine discharge passage (not shown) designed in the main body (110).

Additionally, the medicine discharge port (160) may include an object detection sensor at the bottom where the cup (190) is placed to detect whether the cup (190) is removed and returned. The medicine discharge port (160) may include a moving mechanism for moving the cup (190) to the side compartment (170). The moving mechanism may be driven under the control of the touchscreen device (150).

The side compartment (170) may be arranged at the lower side of the side of the main body (110). The side compartment (170) may be communicated with the medicine discharge port (160) by the control of the touchscreen device (150). For example, a sliding door that is opened and closed by the touchscreen device (150) may be arranged between the side compartment (170) and the medicine discharge port (160), and whether the side compartment (170) and the medicine discharge port (160) are communicated or not may be determined by the opening and closing of the sliding door. The sliding door may be designed to be opened and closed in various ways other than a sliding manner.

The side compartment (170) may include an openable window. The openable window may be opened and closed under the control of the touchscreen device (150). For example, the touchscreen device (150) may open and close the openable window subject to authentication by an authorized user. As a specific example, the touchscreen device (150) may request authentication from the user to open the side compartment (170), and may open the side compartment (170) and allow the cup (190) placed in the side compartment (170) to be taken out only when the user authentication is completed.

User authentication for this can be implemented in various ways. As a non-limiting example, the touchscreen device (150) may be linked to a user terminal (400) of an authorized user (e.g., a doctor) through a network (500) to perform user authentication, or may recognize that user authentication has been performed when an NFC/RFID device containing an authentication key is tagged to the medicine dispenser (100), but is not limited thereto.

The grid chamber (180) may be placed in the main chamber (140). The grid chamber (180) may be separated from the main body (110) and the two main doors (120, 130) by a separate configuration. The grid chamber (180) may have a hexahedral shape, but is not limited thereto, and may have a shape corresponding to the shape implemented by the main body (110) and the two main doors (120, 130).

The grid chamber (180) may include a first body (181), a coupling structure (182), a plurality of slots (183), and a plurality of buttons (184) and a plurality of LEDs (185) arranged corresponding to the plurality of slots (183). The first body (181) may form an outer shape of the grid chamber (180) and may be formed to include a plurality of spaces into which the plurality of slots (183) are inserted in the second direction (Y-axis direction).

The coupling structure (182) may be a structure for coupling the grid chamber (180) to the main body (110). In one embodiment, the coupling structure (182) may have a structure protruding from each side of the first body (181) to be coupled to the main body (110), but is not limited thereto. The coupling structure (182) may be implemented in various methods and structures as understood by a person skilled in the art of the present invention.

The plurality of slots (183) may include a hexahedral space. The plurality of slots (183) may be spaces into which a plurality of cartridges (200) are respectively inserted. According to one embodiment of the present invention, the plurality of slots (183) into which the cartridges (200) are inserted may be implemented as rectangular parallelepipeds having an inclined shape inside the grid chamber (180) so that the medicine contained in the cartridge (200) can be smoothly discharged. For example, the plurality of slots (183) may be implemented inside the grid chamber (180) so that the front of the cartridge (200) faces the opposite direction of the second direction (Y-axis direction) and the opposite direction of the third direction (Z-axis direction) (or, downward direction) and the rear faces the second direction (Y-axis direction) and the third direction (Z-axis direction). However, the present invention is not limited thereto, and the plurality of slots (183) may have a shape that extends in the second direction (Y-axis direction) without change in the third direction (Z-axis direction).

An NFC/RFID reader is arranged on one side of each of the plurality of slots (183), and the NFC/RFID reader can recognize the NFC/RFID of the cartridge (200) arranged in the slot (183). Each of the plurality of slots (183) may include pins for fixing the cartridge (200) at four corners when viewed from the front, and a pair of electrodes arranged for supplying electric energy to the inserted cartridge (200).

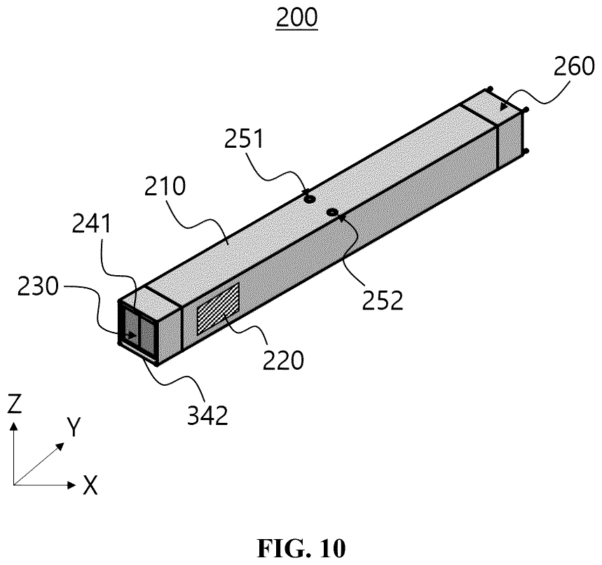

The above NFC/RFID reader can read the NFC/RFID chip (220 in FIG. 10) placed in the cartridge (200) and obtain information about the contents of the cartridge, such as the type of medicine contained in the cartridge (200), information on the designated medicine user, information on the prescribing doctor, and the method of administration. The above pair of electrodes can open the cartridge door (230 in FIG. 10) and supply power necessary to dispense the medicine from the cartridge (200).

Additionally, an infrared sensor may be placed at the front end of each of the plurality of slots (183). The infrared sensor may be used to count the number of medicines (pills) pushed out from the cartridge (200) placed in the slot (183).

A plurality of buttons (184) arranged on the front side of the first body (181) corresponding to the plurality of slots (183) may be physically designed to separate a plurality of cartridges (200) arranged in each of the plurality of slots (183). A plurality of LEDs (185) arranged on the rear side of the first body (181) corresponding to the plurality of slots (183) may be used to indicate whether a cartridge (200) is arranged in the slot (183), whether all of the medicine filled in the cartridge (200) has been dispensed, and whether dispensing of the medicine filled in the cartridge (200) has been canceled by a doctor. For example, the LED (185) may be designed to change color depending on the status of the slot (183) and the cartridge (200), or may indicate the status according to a blinking signal.

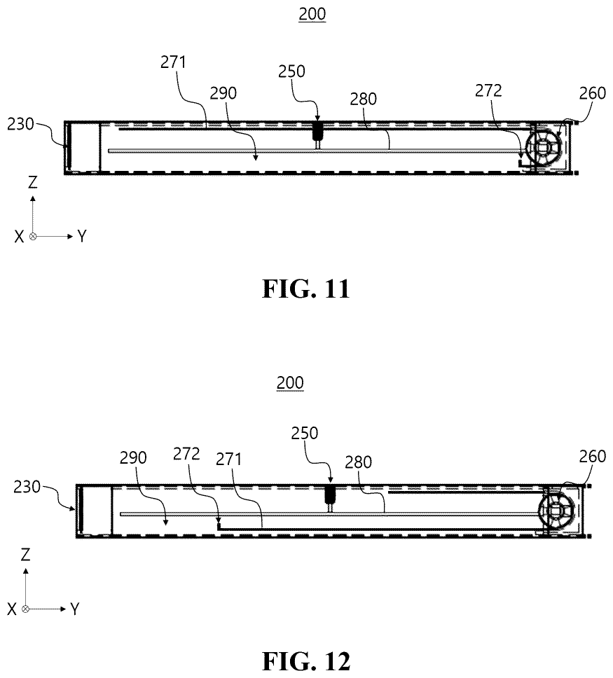

FIG. 10 is a perspective view of a cartridge according to one embodiment of the present invention. FIGS. 11 and 12 are side perspective views of a cartridge according to one embodiment of the present invention.

Referring to FIGS. 10 to 12, a cartridge (200) according to one embodiment of the present invention may include a second body (210), an NFC/RFID chip (220), a flap (230), a pair of connectors (241, 242), a volume control member (250), a driving motor (260), a conveyor belt (270), a volume control panel (280), and a medicine storage space (290).

The second body (210) forms the outer shape of the cartridge (200) and may have a shape for insertion into the slot (183) of the grid chamber (180). For example, the second body (210) may have a rectangular parallelepiped shape whose width in the second direction (Y-axis direction) is greater than that in the first direction (X-axis direction), but is not limited thereto. The shape of the second body (210) may have various shapes corresponding to the shape of the slot (183) of the grid chamber (180).

The NFC/RFID chip (220) may be placed on one side of the second body (210). The position at which the NFC/RFID chip (220) is placed may correspond to the position of the NFC/RFID reader placed in the slot (183). The NFC/RFID chip (220) may store information about a medicine contained in the cartridge (200) through wireless communication. For example, the NFC/RFID chip (220) may store information about the contents of the cartridge, such as the type of medicine contained in the cartridge (200), information about a designated medicine user, information about a prescribing doctor, and a method of taking the medicine.

The NFC/RFID chip (220) can receive information about the medicine contained in the cartridge (200) through wireless communication (e.g., Bluetooth, NFC, RFID, etc.) with a user terminal (400) (e.g., a user terminal of a doctor who prescribed the medicine), but is not limited thereto. In addition, information stored in the NFC/RFID chip (220) can be modified or updated through the user terminal (400).

The flap (230) may be arranged at the front end of the second body (210). The flap (230) may be opened and closed by controlling an electric signal. For example, the flap (230) may be controlled to open and close depending on whether the cartridge (200) is coupled to the main body (110) of the medicine dispenser (100). In other words, the flap (230) may not open even if it is inserted into the slot (183) of the grid chamber (180), and may open only when the grid chamber (180) is coupled to the main body (110). Accordingly, the medicine contained in the cartridge (200) may be prevented from being exposed to the outside before dispensing.

A pair of connectors (241, 242) may be arranged at the front end of the second body (210). For example, a pair of connectors (241, 242) may be arranged at upper and lower corners of the front end of the second body (210), respectively, but is not limited thereto. The position and implementation method of arranging a pair of connectors (241, 242) may be implemented in various ways so that the cartridge (200) receives electrical energy from the medicine dispenser (100).

The volume control member (250) may include two gears (251, 252) and a shaft mechanism arranged correspondingly to each other. The two gears (251, 252) may be arranged on the inner side of the upper surface of the second body (210). The two gears (251, 252) may adjust the volume of the medicine storage space (290) together with the volume control panel (280). The volume control member (250) may adjust the volume of the medicine storage space (290) by pressurizing the volume control panel (280) in the third direction (Z-axis direction).

The degree of pressing of the volume control panel (280) by the two gears (251, 252) can be controlled by the medicine cartridge (100). For example, the touchscreen device (150) can recognize the number of medicines discharged from the cartridge (200) by using an infrared sensor arranged at the front end of each of the plurality of slots (183), and can adjust the volume control member (250) according to the number of medicines discharged.

The drive motor (260), the conveyor belt (270), and the volume control panel (280) may be arranged inside the second body (210). For example, the drive motor (260) may be arranged on the inner rear side of the second body (210), the conveyor belt (270) may be arranged to surround at least a portion of the upper and lower surfaces of the second body (210) while engaging with the drive motor (260), and the volume control panel (280) may be arranged to divide the second body (210) into upper and lower spaces in the third direction (Z-axis direction).

The drive motor (260) has a wheel shape and can be driven to move the conveyor belt (270) inside the second body (210). The conveyor belt (270) can include a main belt (271) and a notch (272). The conveyor belt (270) and the volume control panel (280) can define a medicine storage space (290). For example, the medicine storage space (290) can be a space surrounded by the lower surface of the second body (210), the volume control panel (280), and the notch (272), as illustrated in FIG. 11.

Specifically, before the medicine is dispensed from the cartridge (200), the medicine storage space (290) can have a large volume because the notch (272) is positioned adjacent to the driving motor (260) as shown in FIG. 11. When the cartridge (200) is mounted on the medicine dispenser (100) and dispensed, the medicine placed in the medicine storage space (290) can be dispensed toward the front of the cartridge (200) as the notch (272) moves in the opposite direction (i.e., the front direction) of the second direction (Y-axis direction).

The degree of movement of the conveyor belt (270) by the drive motor (260), i.e., the amount of medicine dispensed, can be controlled by the medicine cartridge (100). For example, the touchscreen device (150) can recognize the number of medicines discharged from the cartridge (200) by using an infrared sensor arranged at the front end of each of the plurality of slots (183), and can adjust the degree of movement of the conveyor belt (270) by the drive motor (260) according to the number of medicines discharged.

Until now, the present invention has been described in detail with reference to the embodiments shown in the drawings. These embodiments are not intended to limit the present invention, but are merely illustrative, and should be considered in an illustrative rather than a restrictive sense. The true technical protection scope of the present invention should be determined by the technical spirit of the appended claims rather than the above description. Although specific terms are used in this specification, they are only used for the purpose of describing the concept of the present invention, and are not used to limit the meaning or the scope of the present invention described in the claims. Each step of the present invention does not need to be necessarily performed in the order described above, and may be performed in parallel, selectively, or individually. Those skilled in the art will understand that various modifications and equivalent other embodiments are possible without departing from the essential technical spirit of the present invention as claimed in the claims. It should be understood that equivalents include both currently known equivalents, as well as equivalents that will be developed in the future, i.e., all components invented to perform the same function, regardless of the structure.

What is claimed is:

1. A medicine dispenser comprising:
a main body forming the overall appearance of the medicine dispenser;
a first main door and a second main door arranged at the rear of the main body and openable;
a main chamber defined by the main body, the first main door, and the second main door;
a touchscreen device arranged at the front of the main body to provide medicine dispensing information and manage a medicine dispensing mechanism;
a grid chamber mounted in the main chamber and into which at least one cartridge containing a medicine is inserted; and
at least one cartridge containing a medicine and including an NFC/RFID chip storing information about the medicine;
wherein the grid chamber includes a plurality of slots into which the cartridge is inserted, and the slots include an NFC/RFID reader for reading the NFC/RFID chip included in the cartridge, and
wherein the touchscreen device dispenses the medicine based on the information about the medicine read through the NFC/RFID reader, wherein the information about the medicine includes at least one of the type of the medicine, information about the designated medicine user, information about the prescribing doctor, and a method of administration.

2. The medicine dispenser according to claim 1, wherein the touchscreen device includes a processor and a memory that execute an application for managing the medicine dispensing mechanism,
and the touchscreen device provides a notification regarding the taking of the medicine to a user terminal of a medicine user according to preset conditions.

3. The medicine dispenser to claim 1, wherein the touchscreen device transmits a notification to the user terminal of the doctor who prescribed the medicine to the medicine user, informing the user of the fact if the medicine user has not received the medicine for a preset period of time.

4. The medicine dispenser according to claim 2, wherein the medicine dispenser dispenses medicines to a plurality of medicine users, and the touchscreen device dispenses medicines to the plurality of medicine users based on information read from an NFC/RFID chip contained in each of the plurality of cartridges.

5. The medicine dispenser according to claim 2, the medicine dispenser further comprising:
a medicine dispensing port disposed at the front lower portion of the main body and including a plastic hood;
a cup disposed inside the medicine dispensing port and containing medicines dispensed from the at least one cartridge;
a side compartment disposed on one side of the medicine dispensing port and capable of connecting with the medicine dispensing port by the control of the touchscreen device;
a moving mechanism for moving the cup from the medicine dispensing port to the side compartment; and
wherein the side compartment includes a window that can be opened to connect with the outside.

6. The medicine dispenser according to claim 5, wherein the touchscreen device controls whether the first main door and the second main door are opened or closed and whether the window of the side compartment is opened or closed based on the authentication of an authorized user.

7. The medicine dispenser according to claim 2, wherein the grid chamber further includes a plurality of infrared sensors arranged at the front end of each of the plurality of slots to count the number of medicines dispensed from the plurality of slots.

8. The medicine dispenser according to claim 7, the grid chamber further includes:
a plurality of buttons arranged corresponding to each of the plurality of slots and for separating the cartridge from the plurality of slots; and
a plurality of LEDs arranged corresponding to each of the plurality of slots and for indicating whether a cartridge is placed in the slot and whether all of the medicine contained in the cartridge has been dispensed.

9. The medicine dispenser according to claim 7, the cartridge includes:
a body having a shape corresponding to the slot and forming the outer shape of the cartridge,
the NFC/RFID chip arranged on one side of the body,
flaps arranged on the front end of the body and openable by controlling an electrical signal,
connectors for receiving electrical energy from the touchscreen device,
a volume control member and a volume control panel arranged in the internal space of the body for controlling the volume of a medicine storage space containing a medicine in the thickness direction of the cartridge, and
a conveyor belt and a driving motor for controlling the volume of the medicine storage space in the horizontal direction of the cartridge.

10. The medicine dispenser according to claim 9, wherein the above volume control member includes a plurality of gears and a shaft mechanism arranged corresponding to the gears, and the volume control panel is arranged to divide the internal space of the body into upper and lower spaces in the thickness direction, and the volume control member pressurizes the volume control panel to control the volume of the medicine storage space.

11. The medicine dispenser according to claim 9, wherein the conveyor belt includes a main belt and a notch arranged at one end of the main belt, and the driving motor engages with the conveyor belt to move the conveyor belt in the horizontal direction, and the medicine contained in the cartridge is pushed in the direction of the flaps by the notch.

12. A medicine dispensing system comprising:
the medicine dispenser according to claim 1;
a user terminal possessed by a medicine user using the medicine dispenser and a doctor who prescribed the medicine to the medicine user; and
a service platform that provides a medicine dispensing-related service to the medicine user in conjunction with the medicine dispenser;
wherein the service platform comprises:
an interface module that provides an application program to the medicine dispenser and the user terminal and performs data communication,
a monitoring module that monitors the operation and status of the medicine dispenser,
a scheduling module that schedules a medicine dispensing method of the medicine dispenser based on a prescription prescribed by the doctor.

13. The medicine dispensing system according to claim 12, wherein the interface module provides suitable data and user interface as visual screens for each of the user terminal of the medicine user and the user terminal of the doctor.

14. The medicine dispensing system according to claim 12, wherein when the medicine dispenser dispenses medicines to a plurality of medicine users, the monitoring module generates monitoring data for each of the plurality of medicine users and provides a notification.

15. The medicine dispensing system according to claim 12, the service platform further includes:
a user management module storing information about each of a plurality of medicine users, and
a medicine management module storing information about a plurality of medicines,
wherein the scheduling module schedules a medicine dispensing method of a medicine dispenser based on the prescription, information about the medicine user, and information about the medicine,
wherein the information about the medicine user includes personal information about the medicine user, a list of prescribed medicines, and information about a medicine dispenser being used by the medicine user, and
wherein the information about the medicine includes an appropriate dosage, a dosing cycle, and an interaction with another medicine for each of the plurality of medicines.
